(19) United States
(12) Patent Application Publication
(10) Pub. No.: US 2012/0129644 A1
(43) Pub. Date: May 24, 2012

(54) TRANSMISSION MEMBER INCLUDING AN ELECTRIC MOTOR HAVING AN INTEGRATED DIFFERENTIAL

(75) Inventors: Balazs Palfai, Fishers, IN (US); Andrew Meyer, Fortville, IN (US); Attila Nagy, Fishers, IN (US)

(73) Assignee: REMY TECHNOLOGIES, L.L.C., Pendleton, IN (US)

(21) Appl. No.: 12/950,404

(22) Filed: Nov. 19, 2010

(51) Int. Cl. F16H 48/08

(52) U.S. Cl. 475/150

(57) ABSTRACT

A transmission member including a housing, a stator assembly arranged within the housing, and a rotor assembly rotatably mounted relative to the stator assembly within the housing. The rotor assembly includes a hub portion that defines, at least in part, a carrier. A differential gear assembly is arranged within the carrier. The differential gear assembly includes first and second planet gears driven by the carrier, and first and second side gears driven by the first and second planet gears.

### BACKGROUND OF THE INVENTION

Exemplary embodiments pertain to the art of electric machines and, more particularly, to an electric machine having an integrated differential.

Currently, electric motors are being employed in vehicles and other machinery to replace and/or augment conventional fossil fuel power systems. Fossil fuel powered vehicles employ an internal combustion engine to drive a transmission that is connected to a vehicle's drive wheels. Many transmissions include an integrated differential that is connected to two or more of the vehicles drive wheels. As the move toward hybrid vehicles progresses, many vehicles now include hybrid transmissions. A hybrid transmission transfers power to the vehicle's drive wheels from both a fossil fuel engine and an electric motor depending upon operating conditions. As such, hybrid transmissions must include not only a mechanical link to the electric motor, but also a mechanical link to the fossil fuel engine. Typically, the fossil fuel engine is coupled to the hybrid transmission through the electric motor. The electric motor is generally mounted to a casing of the hybrid transmission to form a hybrid transmission assembly that is in turn mounted to the fossil fuel engine.

### BRIEF DESCRIPTION OF THE INVENTION

Disclosed is a transmission member including a housing, a stator assembly arranged within the housing, and a rotor assembly rotatably mounted relative to the stator assembly within the housing. The rotor assembly includes a hub portion that defines, at least in part, a carrier. A differential gear assembly is arranged within the carrier. The differential gear assembly includes first and second planet gears driven by the carrier, and first and second side gears driven by the first and second planet gears.

Also disclosed is a rotor assembly for a transmission member. The rotor assembly includes a hub portion that defines, at least in part, a carrier. A differential gear assembly is arranged within the carrier. The differential gear assembly includes first and second planet gears driven by the carrier, and first and second side gears driven by the first and second planet gears.

### BRIEF DESCRIPTION OF THE DRAWINGS

The following descriptions should not be considered limiting in any way. With reference to the accompanying drawings, like elements are numbered alike:

FIG. 1 depicts a perspective view of an transmission member having an integrated differential in accordance with an exemplary embodiment; and

FIG. 2 depicts a cross-sectional view of the transmission member of FIG. 1.

### DETAILED DESCRIPTION OF THE INVENTION

A detailed description of one or more embodiments of the disclosed apparatus and method are presented herein by way of exemplification and not limitation with reference to the Figures.

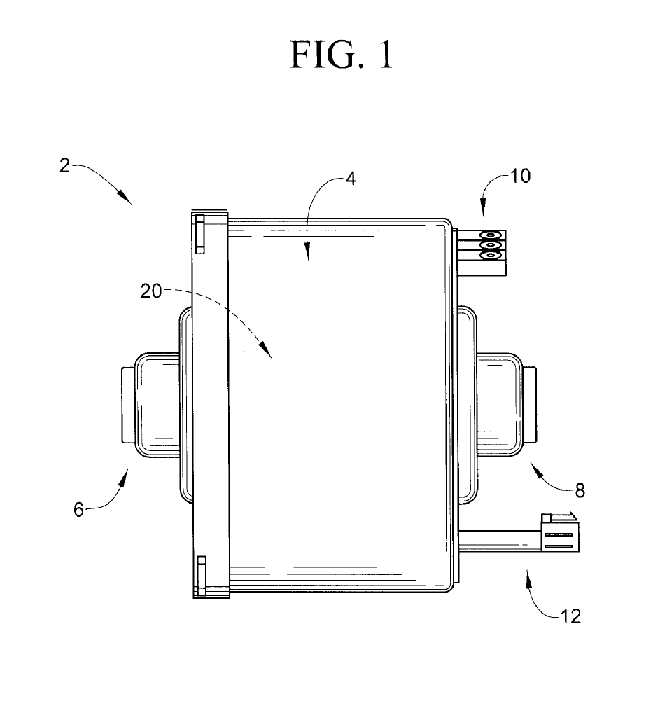

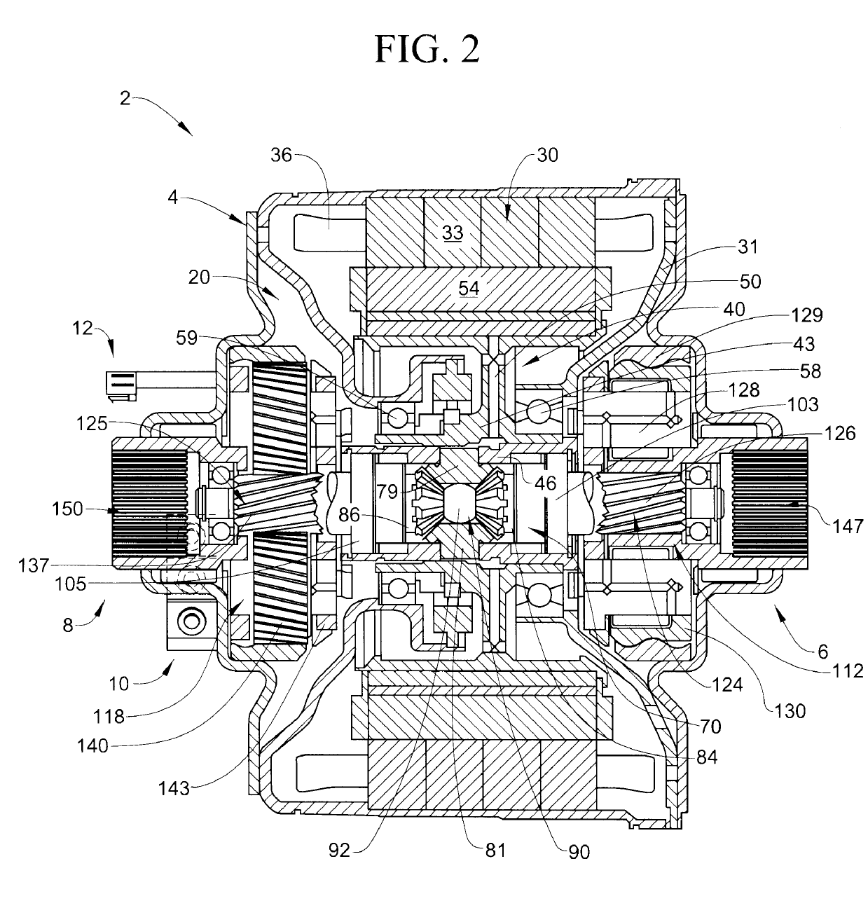

With reference to FIGS. 1 and 2, a transmission member constructed in accordance with an exemplary embodiment is indicated generally at 2. Transmission member 2 includes a housing 4 having a first output hub 6 and a second output hub 8. First and second output hubs 6 and 8 provide an interface to corresponding first and second drive wheels (not shown). Transmission member 2 is also shown to include electric power terminals 10 and a signal or sensor connector 12. As will be discussed more fully below, power terminals 10 and sensor connector 12 are electrically connected to an electric motor 20 arranged within housing 4.

As best shown in FIG. 2, electric motor 20 includes a stator assembly 30 having a stator housing 31. A stator core 33 is arranged within stator housing 31. Stator core 33 is surrounded by a plurality of stator windings 36. Electric motor 20 also includes a rotor assembly 40 that is rotatably mounted relative to stator assembly 30. Rotor assembly 40 includes a hub portion 43 that defines, at least in part, a carrier 46. Hub portion 43 also includes a lamination support element 50 that supports a plurality of rotor laminations 54. Carrier 46 is rotatably supported relative to stator housing 31 by first and second bearings 58 and 59. As will be discussed more fully below, carrier 46 also supports a differential gear assembly 70.

Differential gear assembly 70 includes a first planet gear 79 and a second planet gear 81. First and second planet gears 79 and 81 are rotatably mounted to carrier 46. Although the exemplary embodiments illustrate differential gear assembly 70 with two planet gears, it should be understood that the number of planet gears can vary. Also, while first and second planet gears are shown as rotating in different directions, it should be understood that first and second planet gears could be configured to rotate in the same direction. Differential gear assembly 70 is further shown to include first and second side gears 84 and 86. First and second side gears 84 and 86 mesh or engage with planet gears 79 and 81. In the embodiment shown, a desired spacing between first and second plant gears 79 and 81, and first and second side gears 84 and 86 is established by a spacer 90. Spacer 90 is shown in the form of a bearing 92 having a spherical surface. First side gear 84 leads to a first output member 103 and second side gear 86 leads to a second output member 105. Planet gears 79 and 81 enable first and second output members 103 and 105 to rotate at different rates such as during vehicle turns.

In further accordance with the exemplary embodiment shown, first output member 103 is connected to a first reduction gear 112 and second output member 105 is linked to a second reduction gear 118. First and second reduction gears 112 and 118 serve as an interface between side gears 84 and 86 and a vehicle's drive wheels (not shown). In the exemplary embodiment shown, first reduction gear 112 takes the form of a first planetary gear set 124 and second reduction gear 118 takes the form of a second planetary gear set 125. At this point it should be understood that while shown as planetary gear sets, first and second reduction gears 112 and 118 may take on a variety of forms. As shown, first planetary gear set 124 includes a sun gear 126 surrounded by a plurality of planet gears, one of which is indicated at 128 supported in a planet carrier 130. Similarly, second planetary gear set 125 includes a sun gear 137 surrounded by a plurality of planet gears, one of which is indicated at 140, supported in a planet carrier 143. Planet carrier 130 is coupled to a first output shaft 147 and planet carrier 143 is coupled to a second output shaft 150.

With this arrangement, excitation of stator windings 36 induces an electromagnetic field that develops a rotation of rotor assembly 40. As rotor assembly 40 rotates, carrier 46 rotates first and second planet gears 79 and 81 causing a corresponding rotation of first and second side gears 84 and 86. The rotation of first and second side gears 84 and 86 is translated to first and second output shafts 147 and 150 which drive a vehicle's drive wheels (not shown). The drive wheels can be positioned at a front portion of a vehicle (front wheel drive), at a rear portion of a vehicle (rear wheel drive), or at both the front and rear portion of a vehicle (all wheel drive). At this point it should be understood that the exemplary embodiments provide a transmission member having an integrated electric motor. The electric motor, in turn, includes an integrated differential. By incorporating the differential into the electric motor, an overall size of the transmission member is greatly reduced. The reduction in size leads to a reduction in weight that creates various efficiency enhancements when the transmission member is incorporated into a vehicle. In addition to the reduction in size, integration of the electric motor into the transmission eliminates the need for separate electric motor and transmission assemblies that would require separate installation, maintenance, inventory tracking and the like.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A transmission member comprising:
a housing;
a stator assembly arranged within the housing;
a rotor assembly rotatably mounted relative to the stator assembly within the housing, the rotor assembly including a hub portion that defines, at least in part, a carrier; and
a differential gear assembly arranged within the carrier, the differential gear assembly having first and second planet gears driven by the carrier, and first and second side gears driven by the first and second planet gears.

2. The transmission member according to claim 1, further comprising: a first output member operatively coupled to the first side gear and a second output member operatively coupled to the second side gear.

3. The transmission member according to claim 2, further comprising: a first reduction gear operatively coupled to the first output member.

4. The transmission member according to claim 3, further comprising: a first output shaft operatively coupled to the first reduction gear.

5. The transmission member according to claim 3, wherein the first reduction gear is a planetary gear set.

6. The transmission member according to claim 3, further comprising: a second reduction gear operatively coupled to the second output member.

7. The transmission member machine according to claim 6, further comprising: a second output shaft operatively coupled to the second reduction gear.

8. The transmission member according to claim 6, wherein the second reduction gear is a planetary gear set.

9. The transmission member according to claim 1, further comprising: a bearing mounted between the carrier and the stator assembly.

10. The transmission member according to claim 1, further comprising: a lamination support element operatively connected to the rotor.

11. The transmission member according to claim 10, further comprising: a plurality of laminations mounted to the lamination support element.

12. A rotor assembly for an transmission member comprising:
a hub portion that defines, at least in part, a carrier; and
a differential gear assembly arranged within the carrier, the differential gear assembly having first and second planet gears driven by the carrier, and first and second side gears driven by the first and second planet gears.

13. The rotor assembly according to claim 12, further comprising: a first output member operatively coupled to the first side gear and a second output member operatively coupled to the second side gear.

14. The rotor assembly according to claim 13, further comprising: a first reduction gear operatively coupled to the first output member.

15. The rotor assembly according to claim 14, further comprising: a first output shaft operatively coupled to the first reduction gear.

16. The rotor assembly according to claim 14, wherein the first reduction gear is a planetary gear set.

17. The rotor assembly according to claim 19, further comprising: a second reduction gear operatively coupled to the second output member.

18. The rotor assembly according to claim 17, further comprising: a second output shaft operatively coupled to the second reduction gear.

19. The rotor assembly according to claim 18, wherein the second reduction gear is a planetary gear set.

20. The rotor assembly according to claim 12, further comprising: a plurality of laminations mounted to the hub portion.
